(19) United States
(12) Patent Application Publication
(10) Pub. No.: US 2015/0107706 A1
(43) Pub. Date: Apr. 23, 2015

(54) VORTEX CHAMBER FOR FLUID CONTROL VALVES

(71) Applicant: DELAVAN INC., DES MOINES, IA (US)

(72) Inventors: Jason Ryon, Carlisle, IA (US); Neal Thomson, West Des Moines, IA (US); Philip Buelow, West Des Moines, IA (US)

(73) Assignee: DELAVAN INC., DES MOINES, IA (US)

(21) Appl. No.: 14/190,991

(22) Filed: Feb. 26, 2014

Related U.S. Application Data
(60) Provisional application No. 61/892,808, filed on Oct. 18, 2013.

(51) Int. Cl. F16K 47/04; F16K 15/06; F16K 15/02

(52) U.S. Cl. CPC F16K 47/04; F16K 15/025; F16K 15/066
USPC 137/601.01; 251/121

(57) ABSTRACT

A fluid flow control apparatus includes first and second bodies, an inlet, and an outlet. The first body includes a slot, and the second body includes a vortex chamber. The second body is moveable relative to the first body to align the slot and the vortex chamber. The vortex chamber includes a chamber inlet section, an orifice, and a tapered section that has a frustoconical shape and tapers from the chamber inlet section to the orifice. The chamber inlet section is in fluid communication with the slot when the vortex chamber is aligned with the slot. The inlet is in fluid communication with the slot, and the outlet is in fluid communication with the orifice.

### BACKGROUND

The present invention is related to fluid control valves, and in particular to the use of vortex chambers to control fluid flow.

In fluid systems such as, for example, fuel systems of gas turbine engines, it is desirable to utilize valves to control fluid flow based upon fluid pressure. Prior art valves include, for example, a “keyhole” geometry on a piston of the valve. As the inlet pressure increases, the piston moves axially to align the keyhole with a fluid outlet. A desired relationship between the inlet pressure and the outlet flow rate is accomplished by varying the cross-sectional area of the keyhole in the axial direction. Traditional machining techniques generally cannot be utilized to accomplish this geometry and thus, advanced techniques such as electric discharge machining (EDM) must be implemented. This adds extra time and cost to the production of these fluid control valves. It is desirable to implement a control valve assembly that includes geometries that may be machined using traditional machining techniques.

### SUMMARY

A fluid flow control apparatus includes first and second bodies, an inlet, and an outlet. The first body includes a slot, and the second body includes a vortex chamber. The second body is moveable relative to the first body to align the slot and the vortex chamber. The vortex chamber includes a chamber inlet section, an orifice, and a tapered section that has a frustoconical shape and tapers from the chamber inlet section to the orifice. The chamber inlet section is in fluid communication with the slot when the vortex chamber is aligned with the slot. The inlet is in fluid communication with the slot, and the outlet is in fluid communication with the orifice.

### BRIEF DESCRIPTION OF THE DRAWINGS

FIG. 1 is a perspective cross-sectional view of a fluid control valve that utilizes vortex chambers to control flow rate.

FIG. 2 is a cross-sectional view of a fluid control valve that utilizes vortex chambers to control flow rate.

FIG. 3 is a top view of a piston utilized in a fluid control valve.

FIG. 4 is a perspective view of a face seal that implements vortex chambers to control fluid flow.

### DETAILED DESCRIPTION

A fluid control valve utilizes vortex chambers to control a fluid flow rate through the valve. In an embodiment, a fluid control valve includes a piston that receives a fluid at an inlet pressure. The fluid moves the piston axially relative to a sleeve. The sleeve includes a slot that is in fluid communication with the inlet. The piston includes a vortex chamber that aligns with the slot to provide the fluid to an outlet. The vortex chamber has a chamber inlet and an outlet orifice. The shape of the chamber is frustoconical and tapers from the chamber inlet to the outlet orifice. A variable flow rate is achieved such that the flow rate is greatest when the slot is directly aligned with the outlet orifice.

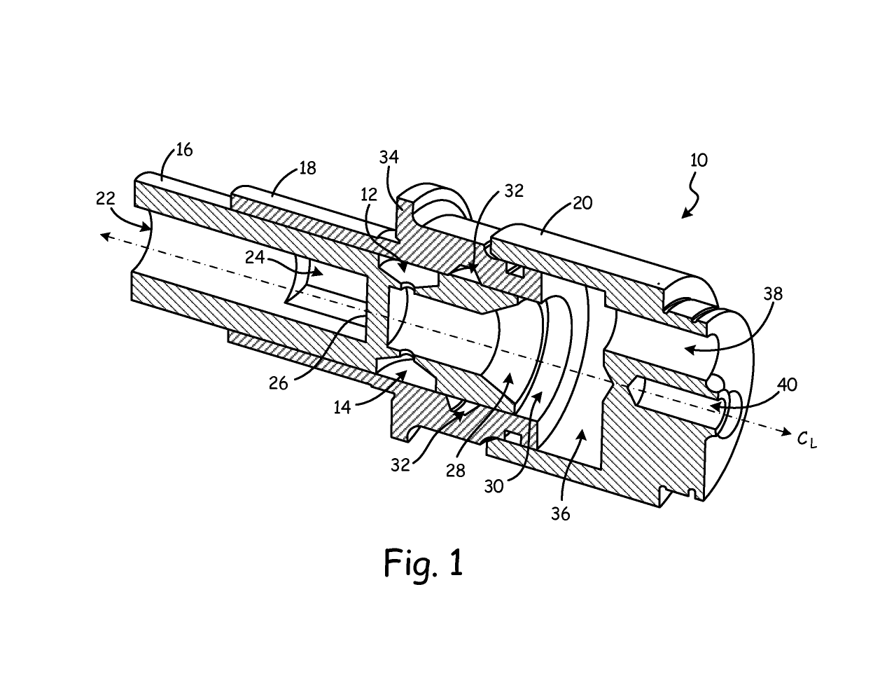

FIG. 1 is a perspective cross-sectional view of fluid control valve 10 that utilizes vortex chambers 12 and 14 to control flow rate. Valve 10 includes first body 16, second body 18, and end cap 20. In the embodiment shown in FIG. 1, first body 16 is a piston and second body 18 is a sleeve. Piston 16 moves relative to sleeve 18. Piston 16 is oriented annularly about centerline C_{L} and includes vortex chambers 12 and 14, inlet 22, slot 24, end wall 26, and outlet 28. Sleeve 18 is oriented annularly about centerline C_{L} and includes bore 30, slot 32, and rim 34. End cap 20 is oriented annularly about centerline C_{L} and includes bore 36, and outlets 38 and 40.

Sleeve 18 receives piston 16 within bore 30. Fluid enters piston 16 through inlet 22. This fluid may be, for example, fuel from a reservoir for a gas turbine engine fuel system. This fluid has an inlet fluid pressure that applies an axial force upon end wall 26. Piston 16 moves axially within sleeve 18 along centerline C_{L} based upon this inlet fluid pressure. Slot 24 is in fluid communication with slot 32 and provides the fluid to slot 32 at the inlet pressure. Slot 32 is annular and extends around the entire circumference of sleeve 18. At low inlet fluid pressures, slot 32 is not in fluid communication with vortex chambers 12 and 14, and thus, no fluid flows through the vortex chambers to outlet 28.

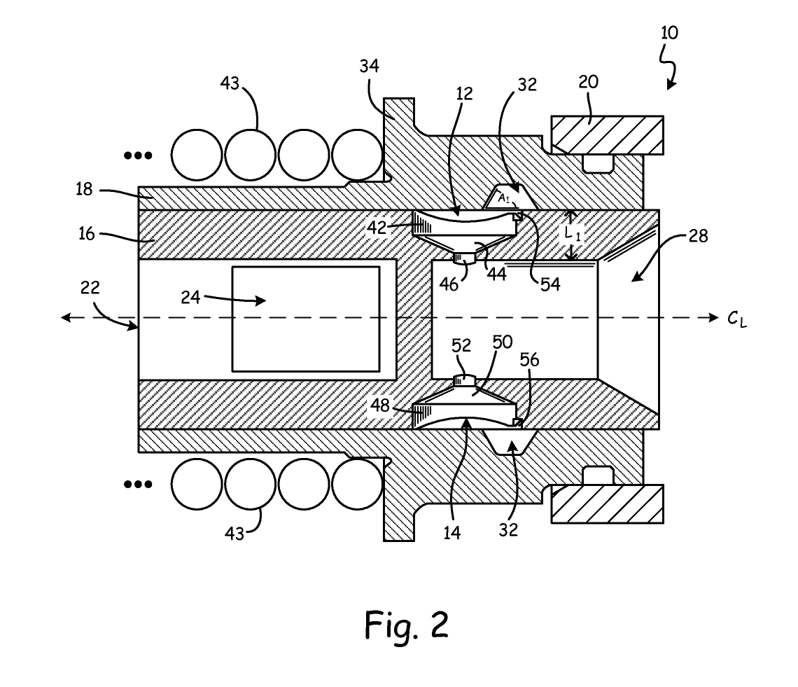

As the inlet pressure of the fluid within inlet 22 increases, piston 16 moves such that vortex chambers 12 and 14 move axially toward annular slot 32. This may be accomplished using any method, such as, for example, a spring (such as spring 43 shown in FIG. 2) implemented between rim 34 and a rim or O-ring connected to piston 16 (not shown). The spring urges valve 10 into a closed position (i.e., slot 32 does not align with vortex chambers 12 and 14). As the inlet pressure increases, valve 10 is urged into an open position (i.e., slot 32 aligns with vortex chambers 12 and 14). When slot 32 aligns with vortex chambers 12 and 14, fluid is provided through vortex chambers 12 and 14 to end cap 20. In the present embodiment, end cap 20 includes outlets 38 and 40. However, end cap 20 may include any number of fluid outlets based upon, for example, the number of fluid circuits within the system.

Vortex chamber 12 has a generally cylindrical inlet portion, a tapered portion, and an outlet orifice. The tapered portion tapers, or narrows, from the inlet portion to the outlet orifice. This cause fluid to swirl within chamber 12 when slot 32 is in fluid communication with chamber 12, but axially offset from the outlet orifice. The further the axial offset between slot 32 and the orifice, the greater the fluid swirl created within vortex chamber 12. The greater the fluid swirl in vortex chamber 12, the lower the fluid flow exiting from chamber 12. Therefore, the fluid flow rate at outlet 28 can be controlled based upon the axial offset between slot 32 the outlet orifice of vortex chamber 12. Vortex chamber 14, or any other vortex chamber included on piston 16 includes a similar geometry. This geometry allows vortex chambers 12 and 14 to be machined using traditional machining tools that include, for example, rotary cutting tools such as end mills or drill bits.

FIG. 2 is a cross-sectional view of fluid control valve 10 that utilizes vortex chambers 12 and 14 to control a fluid flow rate. FIG. 2 illustrates control valve 10 in a position in which slot 32 is in fluid communication with vortex chambers 12 and 14. In this embodiment, valve 10 includes a spring 43 to allow for axial movement of piston 16 in response to an inlet fluid pressure. In other embodiments, any known method may be used to provide axial movement of piston 16 in response to the inlet fluid pressure. Vortex chamber 12 includes chamber inlet portion 42, tapered portion 44 and orifice 46. Vortex chamber 14 includes chamber inlet portion 48, tapered portion 50, and orifice 52. In the present embodiment, chamber inlet portions 42 and 48 are generally cylindrical in shape, tapered portions 44 and 50 are generally frustoconical in shape and taper from inlet portions 42 and 48 to orifices 46 and 52, respectfully. Orifices 46 and 52 are generally cylindrical in shape.

As illustrated in FIG. 2, slot 32 is not directly aligned with orifices 46 and 52. Fluid enters vortex chamber 12 at chamber inlet portion 42. The fluid swirls within chamber 12, and exits vortex chamber 12 at orifice 46. The further the axial offset between slot 32 and orifice 46, the greater the fluid swirl created in vortex chamber 12. The greater the fluid swirl in vortex chamber 12, the lower the fluid flow exiting from orifice 46. Therefore, the fluid flow rate at outlet 28 can be controlled based upon the axial offset between slot 32 and orifice 46. This operation is the same for vortex chamber 14 and any other vortex chambers included annularly about piston 16.

In the embodiment shown in FIG. 2, vortex chambers 12 and 14 are located radially opposite one another to counteract any undesired rotation of piston 16. If piston 16 only includes a single vortex chamber, then the flow of fluid from slot 24 through slot 32 to vortex chamber 12 can cause piston 16 to rotate about centerline C_{L}. To counteract this effect, vortex chambers 12 and 14 are circumferentially spaced about centerline C_{L} at a substantially equal distance. Thus, the fluid forces acting on piston 16 substantially cancel out and the rotation of piston 16 is substantially eliminated. While this may be a desirable feature, it is not necessary, and valve 10 may be implemented with any number of vortex chambers, spaced in various arrangements about piston 16.

In the embodiment shown in FIG. 2, vortex chambers 12 and 14 also include dribble ports 54 and 56, respectively. Dribble ports 54 and 56 are optional and may be implemented to further control the flow rate at outlet 28 based upon the inlet fluid pressure. Dribble ports 54 and 56 axially align with slot 32 prior to slot 32 axially aligning with vortex chambers 12 and 14. This allows a small amount of fluid to enter vortex chambers 12 and 14 from slot 32 prior to slot 32 axially aligning with chamber inlet portions 42 and 48. This is beneficial for applications in which it is desirable to provide some flow, or a greater flow of fluid to outlet 28 for lower inlet pressures.

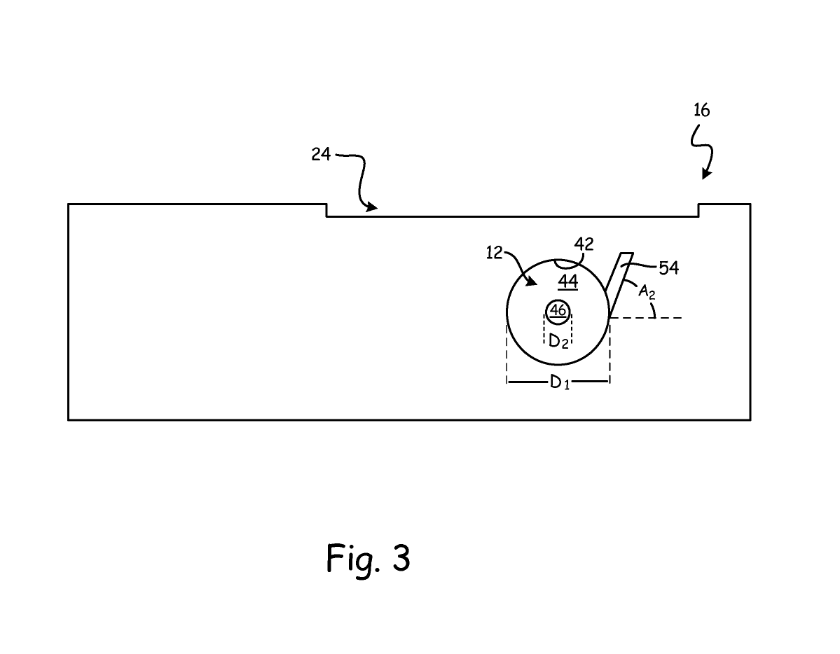

With continued reference to FIG. 2, FIG. 3 is a top view of piston 16 utilized in fluid control valve 10. The geometry of vortex chamber 12 (and any other vortex chamber included on piston 16) may be chosen to obtain a desired inlet pressure to outlet flow rate curve. Some of the geometric properties of chamber 12 (and any other vortex chamber) that may be adjusted to fit a desired inlet pressure to flow rate curve include length L₁ (shown in FIG. 2), diameters D₁ and D₂ (shown in FIG. 3) and angles A₁ (shown in FIG. 2) and A₂ (shown in FIG. 3). Varying one or more of these parameters will adjust the relationship between the fluid inlet pressure and the fluid outlet flow rate. Due to this geometry, the vortex chambers may be machined using traditional machining techniques, which may include, for example, rotary cutting tools. This eliminates the extra time and cost associated with advanced machining techniques such as, for example, electric discharge machining (EDM).

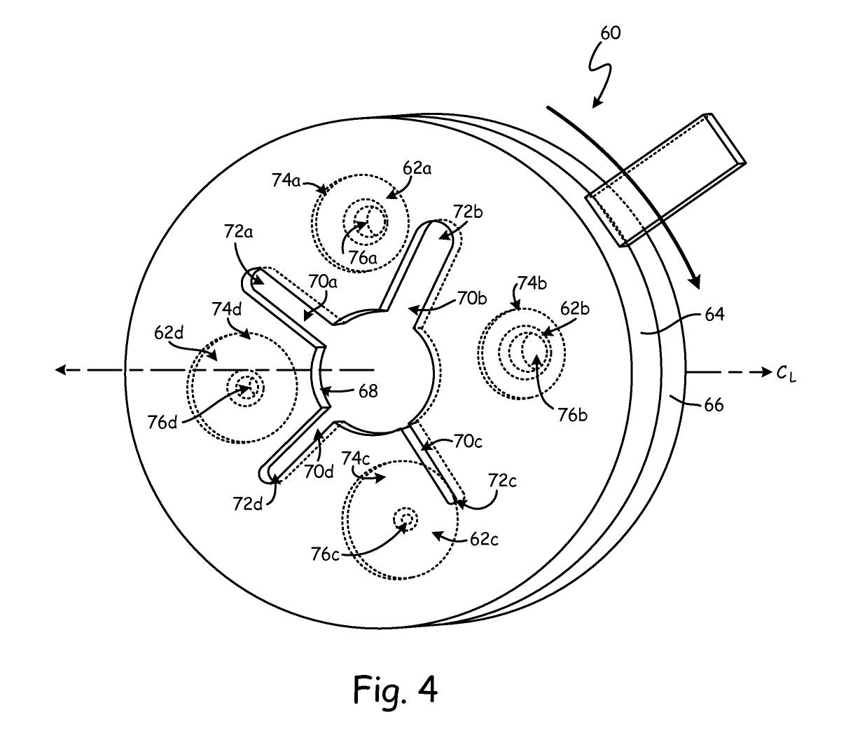

FIG. 4 is a perspective view of face seal assembly 60 that includes vortex chambers 62a-62d to control fluid flow. Face seal assembly 60 includes bodies 64 and 66. Body 64 is annular about centerline C_{L} and includes slot 68 that extends axially through body 64. Slot 68 includes slot arms 70a-70d that extend radially outward from centerline C_{L} to respective slot arm ends 72a-72d. Body 66 is annular about centerline C_{L} and includes vortex chambers 62a-62d, which are shown in dashed lines to indicate that they are hidden by body 64 in this view. Vortex chambers 62a-62d include respective chamber inlets 74a-74d and orifices 76a-76d.

Face seal assembly 60 may be a part of a fluid control valve and includes a fluid inlet and a fluid outlet (not shown). The fluid inlet is in fluid communication with slot 68. The fluid outlet is in fluid communication with orifices 76a-76d. When slot arm ends 72a-72d are not aligned with vortex chambers 62a-62d, no fluid flows from the inlet to the outlet.

Body 64 is rotatable relative to body 66 (illustrated as a clockwise motion) to align slot arm ends 72a-72d with vortex chambers 62a-62d. For example, body 64 may be rotated clockwise using a known method such as a torsion spring or actuator. Slot 68 may be configured such that slot arm ends 72a-72d align with respective vortex chambers 62a-62d at different points in the rotation of body 64 to allow for a desired inlet pressure to outlet flow rate relationship. The geometries of each vortex chamber 62a-62d may also be chosen to further control the inlet pressure to outlet flow rate relationship. For example, the diameter of outlet orifices 76a-76d and/or chamber inlets 74a-74d may be modified to increase or decrease the flow of fluid. Likewise, the geometries of slot arm ends 72a-72d may be modified (i.e., the length, width, and/or shape of each arm end) to increase or decrease the flow of fluid to each of respective chamber inlets 74a-74d.

### DISCUSSION OF POSSIBLE EMBODIMENTS

The following are non-exclusive descriptions of possible embodiments of the present invention.

A fluid flow control apparatus includes, among other possible things: first and second bodies, an inlet, and an outlet. The first body includes a slot, and the second body includes a vortex chamber. The second body is moveable relative to the first body to align the slot and the vortex chamber. The vortex chamber includes a chamber inlet section and an orifice. The chamber inlet section is in fluid communication with the slot when the vortex chamber is aligned with the slot. The inlet is in fluid communication with the slot, and the outlet is in fluid communication with the orifice.

A further embodiment of the foregoing fluid flow control apparatus, wherein the vortex chamber further includes a tapered section that has a frustoconical shape and tapers from the chamber inlet to the orifice.

wherein the first body is a sleeve oriented annularly about a centerline, and wherein the second body is a piston oriented annularly about the centerline.

A further embodiment of any of the foregoing fluid flow control apparatuses, wherein the piston is received within a bore of the sleeve.

A further embodiment of any of the foregoing fluid flow control apparatuses, wherein the slot is an annular slot that extends the full circumference of the sleeve.

A further embodiment of any of the foregoing fluid flow control apparatuses, wherein the piston includes a second vortex chamber, and wherein the first and second vortex chambers are evenly spaced circumferentially about the piston.

A further embodiment of any of the foregoing fluid flow control apparatuses, wherein the first body and the second body form a face seal, and wherein the first body and the second body are annular bodies that extend radially outward from a centerline.

A further embodiment of any of the foregoing fluid flow control apparatuses, wherein the slot extends axially through the first body and comprises a plurality of slot arms that extend radially outward from the centerline.

A further embodiment of any of the foregoing fluid flow control apparatuses, wherein the first vortex chamber is one of a plurality of vortex chambers in the second body, and wherein the second body is moveable relative to the first body to align each of the plurality of slot arms with a respective one of the plurality of vortex chambers.

A fluid control valve includes, among other things: a sleeve, and a piston. The sleeve is oriented annularly about a centerline and includes an annular slot. The piston is oriented annularly about the centerline and includes an inlet, a first vortex chamber, and an outlet. The inlet is in fluid communication with the annular slot. The first vortex chamber includes a chamber inlet section, and an orifice. The outlet is in fluid communication with the orifice. The piston is moveable axially to align the annular slot with the first vortex chamber such that the chamber inlet section is in fluid communication with the annular slot.

A further embodiment of the foregoing fluid control valve, wherein the first vortex chamber further includes a tapered section that has a frustoconical shape and tapers from the chamber inlet to the orifice.

A further embodiment of any of the foregoing fluid control valves, wherein the piston is received within a bore of the sleeve.

A further embodiment of any of the foregoing fluid control valves, wherein annular slot extends the full circumference of the sleeve.

A further embodiment of any of the foregoing fluid control valves, wherein the piston includes a second vortex chamber, and wherein the first and second vortex chambers are evenly spaced circumferentially about the piston.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fluid flow control apparatus comprising:
a first body that includes a slot;
a second body that includes a first vortex chamber, wherein the second body is moveable relative to the first body to align the slot and the first vortex chamber, and wherein the first vortex chamber comprises:
a chamber inlet section in fluid communication with the slot when the first vortex chamber is aligned with the slot; and
an orifice; and
an inlet in fluid communication with the slot; and
an outlet in fluid communication with the orifice.

2. The fluid flow control apparatus of claim 1, wherein the vortex chamber further comprises a tapered section that has a frustoconical shape and tapers from the chamber inlet section to the orifice

3. The apparatus of claim 1, wherein the first body is a sleeve oriented annularly about a centerline, and wherein the second body is a piston oriented annularly about the centerline.

4. The apparatus of claim 3, wherein the piston is received within a bore of the sleeve.

5. The apparatus of claim 4, wherein the slot is an annular slot that extends the full circumference of the sleeve.

6. The apparatus of claim 5, wherein the piston includes a second vortex chamber, and wherein the first and second vortex chambers are evenly spaced circumferentially about the piston.

7. The apparatus of claim 1, wherein the first body and the second body form a face seal, and wherein the first body and the second body are annular bodies that extend radially outward from a centerline.

8. The apparatus of claim 7, wherein the slot extends axially through the first body and comprises a plurality of slot arms that extend radially outward from the centerline.

9. The apparatus of claim 8, wherein the first vortex chamber is one of a plurality of vortex chambers in the second body, and wherein the second body is moveable relative to the first body to align each of the plurality of slot arms with a respective one of the plurality of vortex chambers.

10. A fluid control valve comprising:
a sleeve oriented annularly about a centerline that includes an annular slot; and
a piston oriented annularly about the centerline, the piston comprising:
an inlet in fluid communication with the annular slot;
a first vortex chamber comprising:
a chamber inlet section; and
an orifice; and
an outlet in fluid communication with the orifice; and
wherein the piston is moveable axially to align the annular slot with the first vortex chamber such that the chamber inlet section is in fluid communication with the annular slot.

11. The valve of claim 10, wherein the first vortex chamber further comprises a tapered section that has a frustoconical shape and tapers from the chamber inlet to the orifice.

12. The valve of claim 10, wherein the piston is received within a bore of the sleeve.

13. The valve of claim 12, wherein annular slot extends the full circumference of the sleeve.

14. The valve of claim 10, wherein the piston includes a second vortex chamber, and wherein the first and second vortex chambers are evenly spaced circumferentially about the piston.
